(19) United States
(12) Patent Application Publication
(10) Pub. No.: US 2017/0113578 A1
(43) Pub. Date: Apr. 27, 2017

(54) A SEAT FOR A VEHICLE

(71) Applicant: Adient Luxembourg Holding S.à.r.l., Luxembourg (LU)

(72) Inventor: Masaya SHIRAISHI, Yokohama-shi (JP)

(73) Assignee: Adient Luxembourg Holding S.à.r.l., Luxembourg (LU)

(21) Appl. No.: 15/317,060

(22) PCT Filed: Jun. 10, 2014
(86) PCT No.: PCT/JP2014/065290

§ 371 Date: Dec. 7, 2016

(51) Int. Cl. B60N 2/30; B60N 2/48; B60N 2/20

(52) U.S. Cl. CPC B60N 2/3011; B60N 2/20; B60N 2/4808

(57) ABSTRACT

A seat for a vehicle has a seat cushion; a seat back provided at one end of the seat cushion, which is capable of being held in a standing position with respect to the seat cushion and capable of moving to a forward reclining position on the seat cushion; a head rest provided at a top portion of the seat back, which is installed to be capable of moving up and down and capable of being held at an appropriate position; and a forward reclining mechanism having a function for holding the seat back at the standing position and moving the seat back to the forward reclining position. The forward reclining mechanism is configured to be able to perform a forward reclining of the seat back by moving the head rest to a lower position.

### FIELD OF THE INVENTION

The present invention relates to a seat to be mounted on a vehicle, for example an automobile.

### BACKGROUND OF THE INVENTION

Japanese patent application publication No. H11-240365 is disclosing a related seat for a vehicle. This related seat for a vehicle is capable of taking a lodging position in which a seat back of a foremost seat such as a seat for a driver or a seat for an assistant is reclined forward and laid approximately horizontally on a seat cushion. On an upper side of the seat back, a head rest is installed. On a front side of the foremost seat, mobile body members such as an instrument panel, a console box, a shift lever for a transmission, and a steering wheel are provided.

### SUMMARY OF THE INVENTION

At a time of the forward reclining of the seat back of the foremost seat, there are cases in which the head rest interferes with the mobile body members such as an instrument panel, a console box, a shift lever for a transmission, and a steering wheel. In such cases, the operation is tedious because the seat back has to be reclined forward after the foremost seat is moved backward by a predetermined amount so that the head rest will not interfere.

The present invention has an object of providing a seat for a vehicle in which the head rest does not interfere with the mobile body members provided on a front side of the foremost seat at a time of the forward reclining of the seat back of the foremost seat, so that the operation is easy.

An aspect of the present invention has an essence of a seat for a vehicle, having: a seat cushion; a seat back provided at one end of the seat cushion, which is capable of being held in a standing position with respect to the seat cushion and capable of moving to a forward reclining position on the seat cushion; a head rest provided at a top portion of the seat back, which is installed to be capable of moving up and down and capable of being held at an appropriate position; and a forward reclining mechanism having a function for holding the seat back at the standing position and moving the seat back to the forward reclining position; wherein the forward reclining mechanism is configured to be able to perform a forward reclining of the seat back by moving the head rest to a lower position.

The forward reclining mechanism has: a lever member provided on the seat back at an opposing position on a lower side of a lower end portion of a stay of the head rest, which is capable of rotating by moving the head rest to a lowermost position; a rotation center means for shaft supporting the seat back to be freely rotatable forward and backward; a regulating member provided on a lower side of the rotation center means, for regulating a rotation with the rotation center means as a rotation center; and a linking means for linking between the lever member and the regulating member; wherein the forward reclining mechanism is configured to rotate the lever member with the stay of the head rest by moving the head rest to a lower position, and to be capable of releasing a regulation of the regulating member via the linking means by a rotation of the lever member.

According to the above described configuration, it is configured to be able to perform the forward reclining of the seat back by the forward reclining mechanism, by moving said head rest to a lower position, so that it is possible to make the head rest not to interfere with the mobile body members provided at a front side of the foremost seat at a time of the forward reclining of the seat back of the foremost seat, with an easy operation.

### BRIEF DESCRIPTION OF THE DRAWINGS

FIG. 1 is a plan view of a seat for an automobile, according to one embodiment of the present invention.

FIG. 2 is a plan view after moving only a center seat of the seat for the automobile of FIG. 1 to a foremost position.

FIG. 3 is a side view showing a relationship among a standing position and a forward reclining position of a seat back of the center seat of FIG. 1 and FIG. 2 and mobile body members.

FIG. 4 is a side view showing a forward reclining mechanism of a seat back of the center seat of FIG. 1 and FIG. 2.

FIG. 5 is an enlarged side view around a plate of FIG. 4.

### DETAILED DESCRIPTION OF THE INVENTION

The object of providing a seat for a vehicle in which the head rest does not interfere with the mobile body members provided on a front side of the foremost seat at a time of the forward reclining of the seat back of the foremost seat, so that the operation is easy, is realized by the following configuration. Namely, it has: a seat cushion; a seat back provided at one end of the seat cushion, which is capable of being held in a standing position with respect to the seat cushion and capable of moving to a forward reclining position on the seat cushion; a head rest provided at a top portion of the seat back, which is installed to be capable of moving up and down and capable of being held at an appropriate position; and a forward reclining mechanism having a function for holding the seat back at the standing position and moving the seat back to the forward reclining position; wherein the forward reclining mechanism is configured to be able to perform a forward reclining of the seat back by moving the head rest to a lower position.

### Embodiments

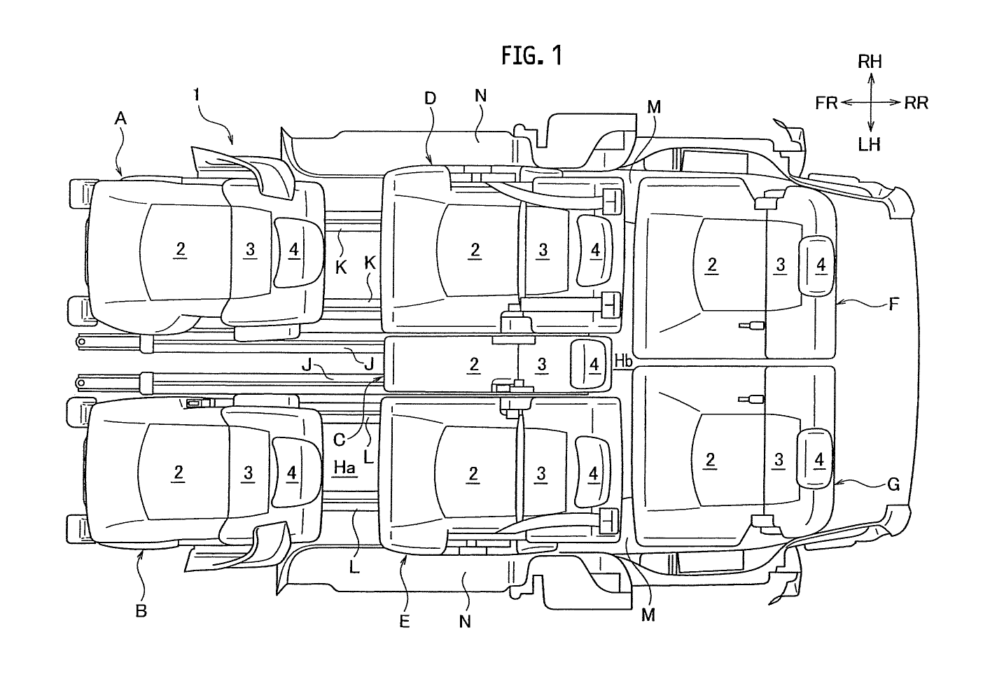

In the following, a seat 1 for an automobile according to one embodiment of the present invention will be described, using FIG. 1 to FIG. 5. The seat 1 for an automobile includes foremost seats A, B of the automobile (first row seats), seats C, D, E arranged at immediately rear side RR of the first row seats (second row seats), and seats F, G arranged at immediately rear side RR of the second row seats (third row seats). The seat A is located on a right side RH, and the seat B is located on a left side LH. A center seat C is located on a center in a left and right direction of the automobile. The seat D is arranged at immediately rear side RR of the seat A. The seat E is arranged at immediately rear side RR of the seat B. The seat F is arranged at immediately rear side RR of the seat D. The seat G is arranged at immediately rear side RR of the seat E. Each of the seats A-G is configured by a seat cushion 2, a seat back 3, and a head rest 4. The seat cushion 2, the seat back 3 and the head rest 4 are respectively different in shape depending on the seats A-G. As is well known, the seat cushion 2 has a function for seating, the sear back 3 has a reclining function for an upper half of the body, and the head rest 4 has a function for holding a passenger's head portion. To these seats A-G, some peripheral mechanism components such as a safety belt and a reclining device are provided respectively, but their description is omitted as they are well known.

On the seat cushions 2 of the seats A-G, the well known movable rails (not shown) which are capable of moving in a front side FR and a rear side RR are provided. The movable rails are freely movable in a front side FR and a rear side RR and capable of stopping at an appropriate position, on respective fixed rails J, K or L provided in parallel on a floor Ha. The fixed rails L are extending from a front position of the seat A and the seat B to a rear position of the seat D and the seat E. The movable rails (not shown) of the center seat C are freely movable on the fixed rails J. On the fixed rails K, the seat A and the seat D are provided to be freely movable. On the fixed rails L, the seat B and the seat E are provided to be freely movable. Note that the fixed rails K for the seat D may be separate components from the fixed rails for the seat A. Also, the fixed rails L for the seat E may be separate components from the fixed rails for the seat B.

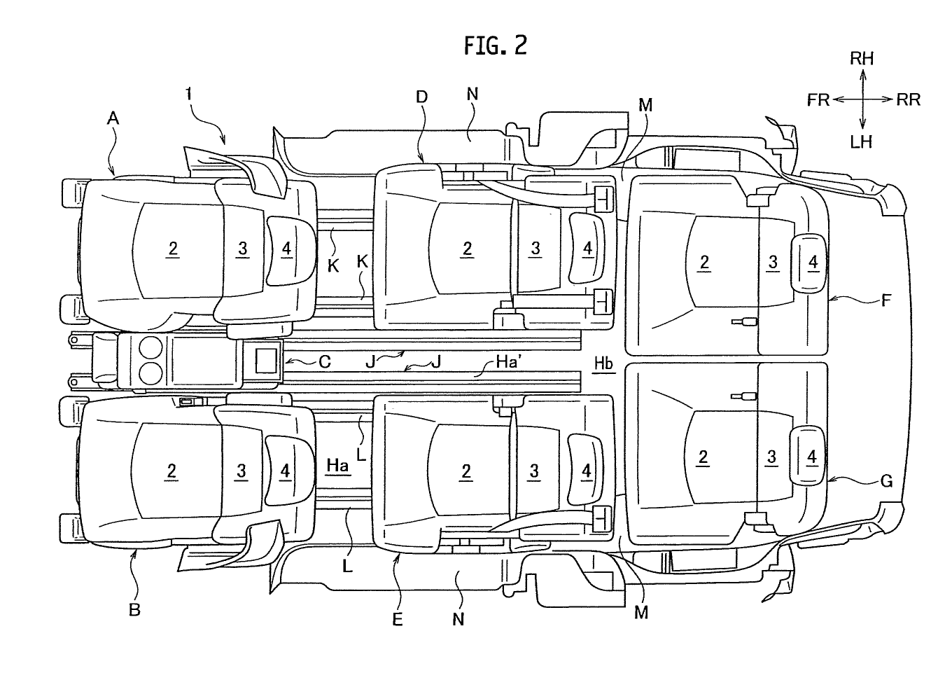

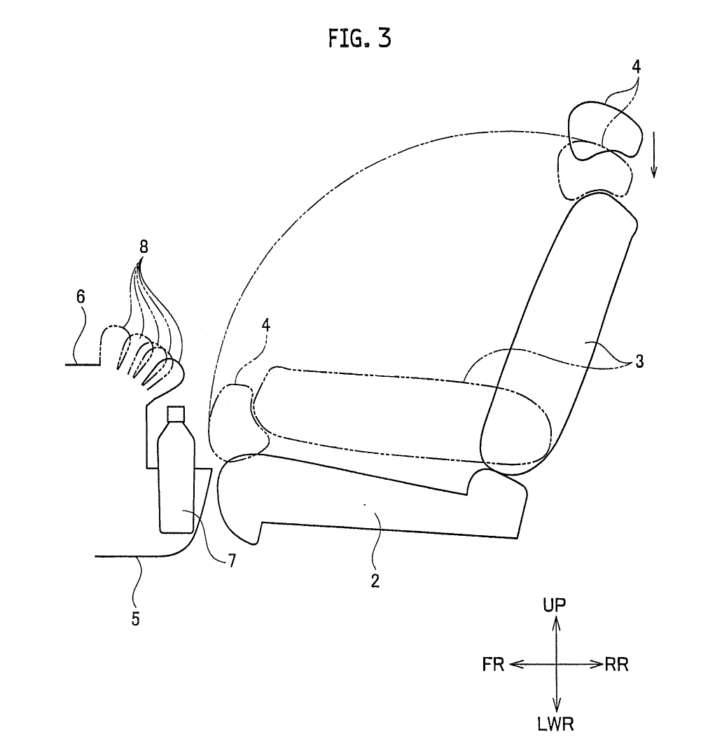

As shown in FIG. 1, the center seat C is capable of comfortably supporting a passenger seating on the seat cushions 2, 2, 2 which are consecutive from a left side LH to a right side RH, in a state of being located between left and right of the seat D and the seat E, but when it is moved to a front side FR on the fixed rails J and positioned between the seat A and the seat B as shown in FIG. 2, the seat cushions 2, 2, 2 of the seat A, the seat B and the center seat C will become consecutive from a left side LH to a right side RH. In this state, a space is formed at a vacant site Ha′ where the center seat X was present between the seat D and the seat E. The seat back 3 of the center seat C is freely selectable between a posture in which a seating is possible, as indicated by a solid line in FIG. 1 and FIG. 3, and a posture in which it becomes an arm rest or capable of supporting small articles as it is reclined forward with a back side of the seat back 3 on an upper side, as indicated by a double dotted line in FIG. 3 (and by a solid line in FIG. 2).

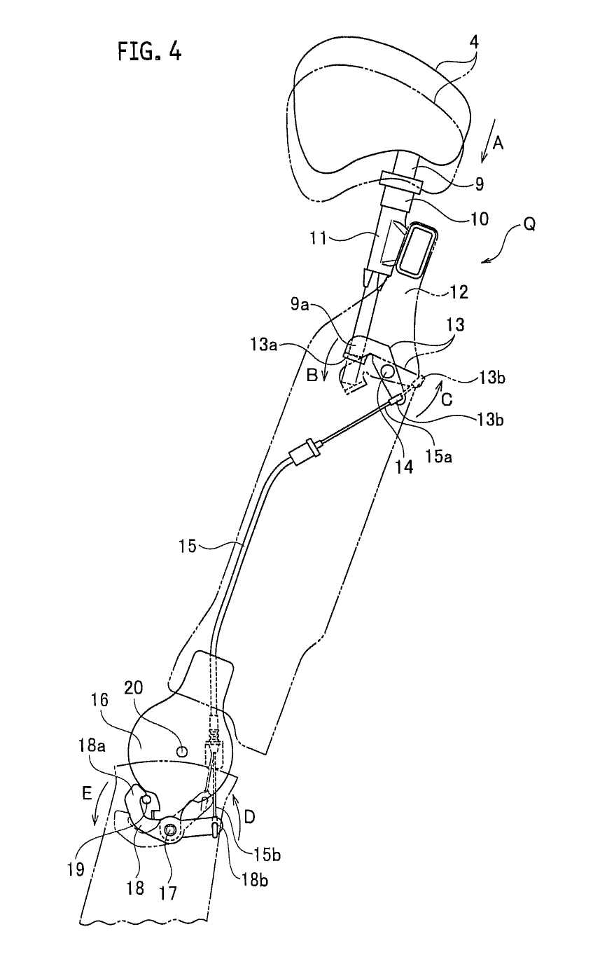

The seat back 3 of the center seat C is provided at one end of the seat cushion 2, and capable of being held in a standing position with respect to the seat cushion 2 and capable of moving to a forward reclining position on the seat cushion 2, by a forward reclining mechanism Q. The forward reclining mechanism Q is configured such that the forward reclining of the seat back 3 becomes possible, by moving the head rest 4 from an upper position indicated by a solid line in FIG. 4 to a lowermost position shown by a double dotted line in FIG. 4. The up/down position of the head rest 4 may be two stages as shown in FIG. 3 and FIG. 4, or may be made such that the stopping is possible at more numerous positions.

Next, the detail of said forward reclining mechanism Q will be described. The forward reclining mechanism Q is configured by a lever member 13, a rotation center means 20 for shaft supporting the seat back 3 to be freely rotatable forward and backward, a regulating member 18 provided on a lower side LWR of the rotation center means 20, for regulating a rotation with the rotation center means 20 as a rotation center, and a linking means 15 for linking between the lever member 13 and the regulating member 18.

The lever member 13 is provided on a seat back frame 12 of the seat back 3 via a first pin 14 to be capable of rotating upward and downward, and one end portion 13a of the lever member 13 is provided on an opposing position on a lower side LWR of a lower end portion 9a of a stay 9 of the head rest 4. Another end portion 13b of the lever member 13 is formed at a rear side RR which is an opposite side from the one end portion 13a via the first pin 14. The stay 9 is in a column shape suspended from the head rest 4, supported to be freely movable up and down via a holder 10 made of a synthetic resin, within a hollow frame 11 that is welded to and supported by the seat back frame 12, and locked at an appropriate position.

The regulating member 18 is provided to be freely rotatable upward and downward by a second pin 17 on an arm 16a protruding to a lower side LWR of a plate 16 that holds the rotation center means 20, with a hook portion 18a of a hook shape formed on a front side FR so that a third pin 19 is in proximity to the plate 16 and does not drop, and an attachment portion 18b of a straight line shape formed on a rear side RR. A stopper 16b is formed on a lower side LWR and a front side FR of the plate 16, which is regulating the regulating member 18 not to interfere with the plate 16.

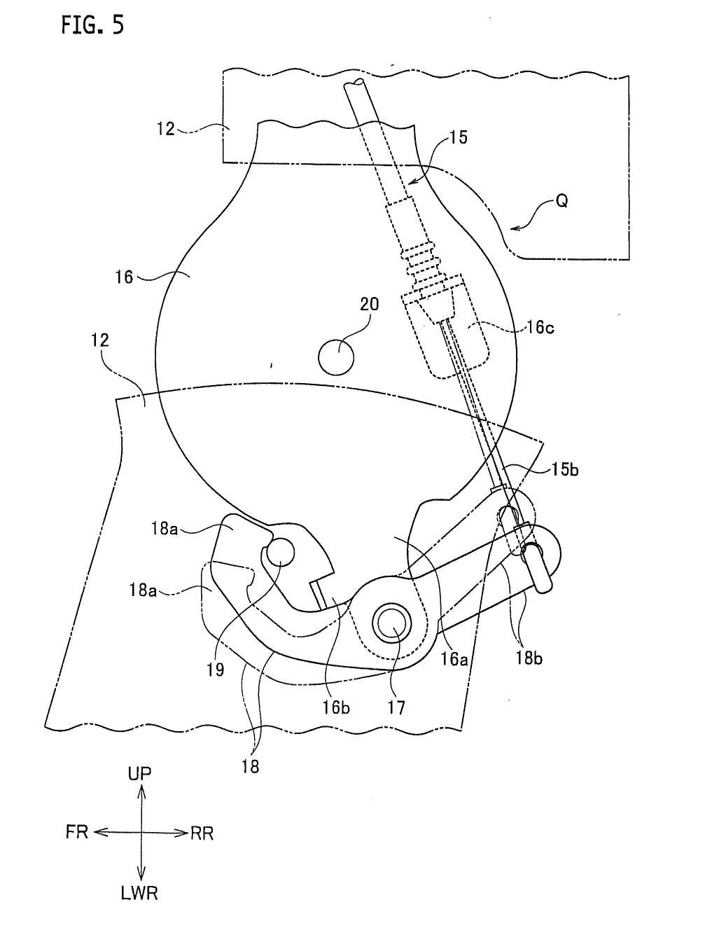

To the another end portion 13b of the lever member 13 and the attachment portion 18b of the regulating member 18, inner cables 15a, 15b of the linking means 15 are linked. To the plate 16 of FIG. 5, a bracket 16c is welded and supported, to hold the linking means 15.

According to the present embodiment, when the head rest 4 is at a position indicated by a solid line in FIG. 4 which is capable of protecting a head portion of a passenger not shown in the figure, because the third pin 19 is held by the regulating member 18, the seat back 3 is held in a state not capable of performing the forward reclining.

When the head rest 4 is moved to the lowermost position indicated by a double dotted line in FIG. 4, for example, it is rotated as the one end portion 13a of the lever member 13 is moved to a lower side LWR by the lower end portion 9a of the stay 9 of the head rest 4, and the attachment portion 18b of the regulating member 18 is moved to an upper side UP via the linking means 15 as the another end portion 13b of the lever member 13 is moved to an upper side UP. As the attachment portion 18b is moved to an upper side UP, the hook portion 18a of the regulating member 18 moves to a position indicated by a double dotted line, such that a movement regulation of the third pin 19 is released and a movement of the third pin 19 is freed, so that the forward reclining of the seat back 3 becomes possible. In other words, by an easy operation of moving the head rest 4 to the lowermost position, it becomes possible to make the head rest 4 not to interfere with the mobile body members such as an instrument panel 6, a console box 5 holding a drink container 7 and the like, a shift lever 8 of a transmission, and a steering wheel (not shown) that are provided in a front side FR of the seats A-C, at a time of the forward reclining of the seat backs 3 of the seats A-C having their head rests 4 provided at foremost positions.

Note that the head rest 4 is moved to the lowermost position in the explanation described above, but the moving position of the head rest 4 is not to be limited. The moving position of the head rest 4 suffices to be a lower position such that the head rest 4 does not to interfere with the mobile body members such as an instrument panel 6, a console box 5, a shift lever 8, and a steering wheel that are provided in a front side FR, at a time of the forward reclining of the seat backs 3.

In the above, the embodiment of the present invention has been described, but the present invention is not to be limited to the above described embodiment, and various modifications are possible.

1. A seat for a vehicle, having:
a seat cushion;
a seat back provided at one end of said seat cushion, which is capable of being held in a standing position with respect to said seat cushion and capable of moving to a forward reclining position on said seat cushion;
a head rest provided at a top portion of said seat back, which is installed to be capable of moving up and down and capable of being held at an appropriate position; and
a forward reclining mechanism having a function for holding said seat back at said standing position and moving said seat back to said forward reclining position;
characterized in that said forward reclining mechanism is configured to be able to perform a forward reclining of the seat back by moving said head rest to a lower position.

2. The seat for the vehicle as described in claim 1, wherein said forward reclining mechanism has:
a lever member provided on said seat back at an opposing position on a lower side of a lower end portion of a stay of said head rest, which is capable of rotating by moving said head rest to a lowermost position;
a rotation center means for shaft supporting said seat back to be freely rotatable forward and backward;
a regulating member provided on a lower side of said rotation center means, for regulating a rotation with said rotation center means as a rotation center; and
a linking means for linking between said lever member and said regulating member;
characterized in that said forward reclining mechanism is configured to rotate said lever member with the stay of said head rest by moving said head rest to the lowermost position, and to be capable of releasing a regulation of said regulating member via said linking means by a rotation of said lever member.
